(19) United States
(12) Patent Application Publication
(10) Pub. No.: US 2025/0190164 A1
(43) Pub. Date: Jun. 12, 2025

(54) SYSTEM AND METHOD FOR SECURELY MANAGING REAL ESTATE RENTALS USING A MULTI-WINDOW DISPLAY SYSTEM

(71) Applicant: Altura Innovations, LLC, Mobile, AL (US)

(72) Inventor: Robert B. Hanson, Mobile, AL (US)

(21) Appl. No.: 18/974,656

(22) Filed: Dec. 9, 2024

Related U.S. Application Data
(60) Provisional application No. 63/608,120, filed on Dec. 8, 2023.

(51) Int. Cl. G06F 3/14; G06F 3/04842; G06F 9/451; G06T 11/60; G06V 10/40; H04L 9/40

(52) U.S. Cl. CPC G06F 3/1454; G06F 3/04842; G06F 9/451; G06T 11/60; G06V 10/40; H04L 63/0428; H04L 63/061; H04L 63/107

(57) ABSTRACT

The present disclosure provides A system and method for Secure Multi-Window Real Estate Display. This system facilitates the improved efficiency and workflow for real estate rentals, employing a secure, multi-window interface that allows real estate agents, property managers, and investors to access, manage, and display various types of real estate-related data concurrently. The system's primary dynamic feature is the ability to present multiple information streams simultaneously, such as virtual property tours, rental applications, market analysis, and property management communications. Each display window can be customized to show different aspects of a property, demographic trends, financial calculations, or tenant or buyer information, enhancing the efficiency and interaction in the real estate rental process. The system integrates advanced security measures, including biometric recognition and secure ID verification, to ensure confidential data pertaining to properties, buyers and tenants is securely managed.

### CROSS-REFERENCE TO RELATED APPLICATIONS

This application claims priority from U.S. provisional application 63/608,120 filed Dec. 8, 2023, the disclosure of which is incorporated herein by reference.

### FIELD OF THE DISCLOSURE

The present disclosure is generally related to providing an enhanced presentation and management of real estate rental data utilizing a multi-window display interface for efficient workflow and secure information handling in the real estate rental market.

### BACKGROUND

The real estate rental and sales market faces significant challenges, including workflow inefficiencies and data management complexities. Property managers, agents, and investors struggle with handling vast amounts of data, including property listings, tenant applications, maintenance requests, and financial transactions. This fragmentation can result in time-consuming processes, errors in data handling, and challenges in effectively presenting properties to potential tenants and buyers.

Furthermore, the market is also vulnerable to security breaches due to the sensitive nature of the information handled, such as personal tenant and buyer details, financial records, and proprietary market data. The need for real estate professionals to share information with various stakeholders further amplifies this risk. As consumer preferences continue to shift towards more interactive and immersive experiences, there is a growing need for innovative solutions that address these challenges and enhance operational efficiency, security, and user experience.

### SUMMARY

Disclosed are systems, apparatuses, methods, computer readable medium, and circuits for According to at least one example, a computer-implemented method of customizing a multi-view display with interactive and dynamic features, includes receiving, by a processing unit of a display, a first request to cast at least a portion of a first user interface of a first computing device, receiving, by the processing unit of the display, a second request to cast at least a portion of a second user interface of a second computing device, securing, over a communication network, isolated encryption protocols for data transfer between the processing unit of the display to the first computing device and to the second computing device.

In some cases, the method includes receiving, by the processing unit, real-time first image data reflecting the at least a portion of the first user interface from the first computing device and real-time second image data reflecting the at least a portion of the first user interface from the first computing device, processing the real-time first image data and the real-time second image data to extract a plurality of dynamic features that adjust in real-time to the real-time first image data and the real-time second image data.

In some cases, the method includes generating, by the processing unit, a custom dynamic view based on the plurality of dynamic features in at least two different windows associated with the real-time first image data and the real-time second image data, respectively, creating mirrored image data based on the custom dynamic view for a display user interface of the display, transmitting the mirrored image data to the display, receiving an interaction with a dynamic feature associated with the real-time second image data to perform an action on one or more dynamic features associated with the real-time first image data, generating operations based on the action, where the operations include one or more operations at the first computing device.

In some cases, the method includes sending the generated operations to the first computing device, receiving updated real-time first image data from the first computing device, generating, by the processing unit, updated dynamic features in an updated custom dynamic view based on the updated real-time first image data, creating an updated mirrored imaged data based on the updated custom dynamic view, and transmitting the updated mirrored image data to the display.

In another example, a display for customizing a multi-view display with interactive and dynamic features, includes a storage configured to store instructions. The display also includes one or more processors configured to execute the instructions.

### BRIEF DESCRIPTION OF THE SEVERAL VIEWS OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a system for presenting real estate rental information.

FIG. 2 illustrates an example method performed by a secure casting network.

FIG. 3 illustrates an example method performed by a display controller module.

FIG. 4 illustrates an example method performed by a user interface module.

FIG. 5 illustrates an example method performed by a security module.

FIG. 6 illustrates an example method performed by a virtual tour module.

FIG. 7 displays an example method performed by a rental management module.

FIG. 8A illustrates an example method for customizing a multi-view display with interactive and dynamic features.

FIG. 8B illustrates an example method for customizing a multi-view display with interactive and dynamic features.

FIG. 9 illustrates a block diagram of an exemplary computing system that may be used to implement an embodiment of the present invention.

FIG. 10 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

In the dynamic landscape of the real estate rental market, workflow efficiency and data management present significant challenges. Property managers, real estate agents, and investors grapple with the complexity of handling vast amounts of data, including property listings, tenant applications, maintenance requests, and financial transactions. The traditional methods of managing these elements often lead to inefficiencies, with critical information spread across multiple platforms and physical documents. This fragmentation can result in time-consuming processes, errors in data handling, and challenges in effectively presenting properties to potential tenants. The market's rapid pace demands swift decision-making and the ability to access and analyze information quickly and accurately. There is a need to streamline these workflows and consolidate data management to enhance efficiency and accuracy in the real estate rental process.

Another prominent issue in the real estate rental sector is the secure handling of sensitive information. With the increasing digitalization of rental processes, there is an inherent risk of data breaches and unauthorized access to confidential information, such as personal tenant and buyer details, financial records, and proprietary market data. Current systems often lack robust security measures, leaving room for potential vulnerabilities. This situation is exacerbated by the need for real estate professionals to share information with various stakeholders, including tenants and buyers, property owners, and service providers, which multiplies the risk of data exposure. There is a need to implement advanced security protocols that safeguard sensitive information while allowing for the necessary flow of data between relevant parties.

Furthermore, the real estate rental market is witnessing a shift in consumer preferences and behaviors. Prospective tenants, buyers, and investors now seek more interactive and immersive ways to explore properties and make informed decisions. Traditional property viewing methods, like physical tours or simple online listings, are often inadequate in providing a comprehensive understanding of a property. Additionally, the decision-making process in rentals involves comparing multiple properties, analyzing market trends, and considering financial implications, which can be overwhelming without a structured and intuitive presentation of information. There is a need to enhance the property viewing and decision-making experience by leveraging technology to present information in an engaging, organized, and insightful manner.

Considering these challenges, the real estate rental market is ripe for innovation that addresses workflow inefficiencies, data security concerns, and the evolving preferences of consumers. There is a need to introduce a system that not only streamlines data management and enhances operational efficiency but also incorporates robust security measures and offers an immersive, informative experience for users. This need underlines the importance of developing a solution that can revolutionize the way real estate rental processes are conducted, leading to a more efficient, secure, and user-friendly market environment.

The present disclosure provides a system that leverages a secure, multi-window interface to simultaneously present a multitude of real estate-related data streams. A window can refer to any contiguous section of a display screen that is visually isolated from other sections, including but not limited to individual windows, sub-windows, or even regions within a single window. In various scenarios, multiple windows may be nested within one another, with each window containing its own set of sub-windows or other visual elements. For example, a window might include several sub-windows that display different types of data, such as property listings, maps, and videos. Similarly, a display screen may include two or more windows side-by-side, even when they are part of the same application window.

For real estate professionals-agents, property managers, and investors-this means a capability to access, manage, and visually display diverse information types in parallel. From showcasing virtual property tours and processing rental applications to conducting in-depth market analysis and managing property-related communications, the system handles various data facets. Each display window is fully customizable, allowing for the tailored presentation of specific property features, demographic insights, financial analytics, and tenant or buyer details. This customization significantly boosts process efficiency and enhances stakeholder interactions within the rental procedure. Furthermore, the system's commitment to data security is uncompromising, incorporating state-of-the-art measures like biometric recognition and secure ID verification to protect sensitive property and tenant and buyer information, thereby addressing critical data privacy concerns in the real estate rental industry.

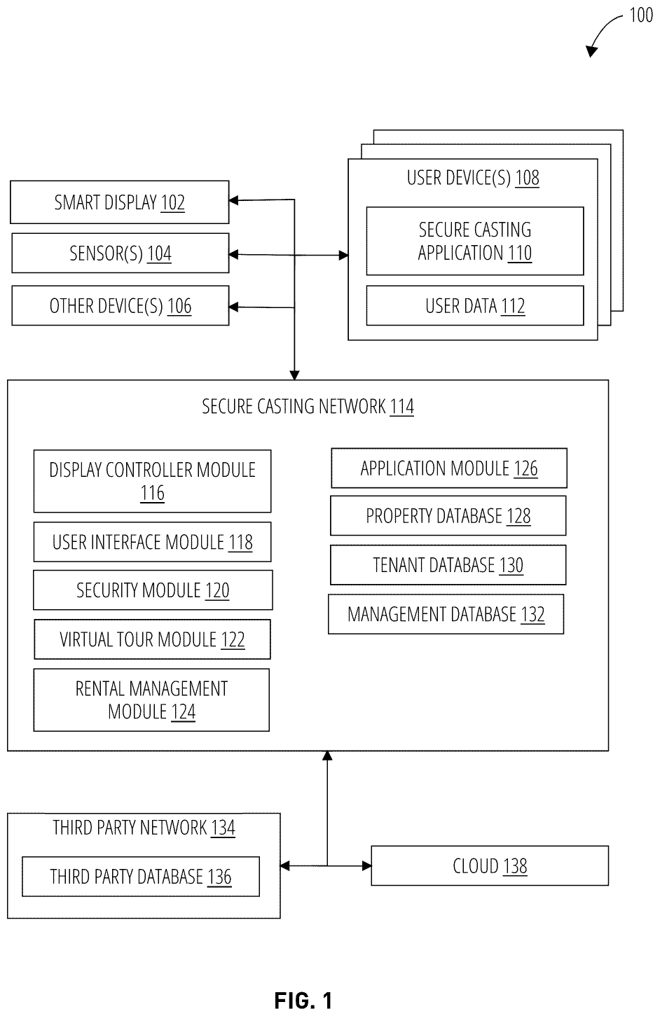

FIG. 1 illustrates a system for presenting real estate rental information comprising the following: a smart display 102 integrated within a real estate rental data management system. Each smart display 102 includes processors, a graphical display unit, and memory. These displays render primary data windows, such as virtual property tours or market analysis, and secondary data windows, like financial calculations or tenant/buyer profiles, on a single device or across interconnected devices.

Following multi-layer authentication, which involves pattern recognition and permission-level verification, users can send signals to generate primary windows and contextually aware secondary windows. For example, an agent can display property details in a primary window while concurrently showing demographic data or lease terms in secondary windows, facilitating an interactive presentation for potential investors or tenants and buyers.

Sensor(s) 104 in this system are a means to gather and provide data about real estate rental properties. The sensor(s) can include environmental monitoring devices within a property, such as temperature or humidity sensor. For instance, in a property management context, the sensor(s) 104 could monitor building conditions or tenant occupancy patterns, feeding this data into the smart display 102 for real-time property status updates. This integration allows property managers to monitor and respond to property needs efficiently.

Other device(s) 106 encompass various smart devices within a rental property or agency, such as connected cameras for virtual tours or automated door locks for controlled access. These devices are integrated into the system, enhancing security and operational efficiency. For example, a connected camera could be used during a virtual property tour, displaying live footage in one of the smart display 102 windows, while an automated door lock system could provide controlled access data to another window, ensuring secure and streamlined property access management.

The user device(s) 108 includes computing platforms like smartphones, tablets, or computers, serving as remote interfaces for interaction with the secure multi-window display system. Through multi-layer authentication, user device(s) 108 enables users to transmit signals for casting data windows across display devices. For example, in a rental agency, an agent using a tablet can initiate the display of a virtual property tour on a smart display 102, while simultaneously pulling up tenant application forms or credit check data on secondary windows, enhancing client engagement and streamlining the rental application process.

The secure casting application 110 on user device(s) 108 is the software interface for managing multi-window displays. It controls the casting of data windows after completing a multi-layer authentication process, including pattern recognition, including such as scanning a QR code displayed on smart display 102. In a real estate investment scenario, the secure casting application 110 can facilitate the simultaneous presentation of property listings, ROI calculations, and demographic trends across multiple smart display 102, aiding investors in making informed decisions. User data 112 on user device(s) 108 consists of information required for presenting multi-window displays. This includes authentication data for pattern recognition and permission-level verification. For property management applications, user data 112 can contain maintenance schedules and tenant requests, which can be displayed in secondary windows of smart display 102, allowing property managers to efficiently coordinate and communicate property-related tasks.

The secure casting network 114 operates as the communicative framework for the secure multi-window display system tailored for real estate rental workflows. It facilitates the transfer of computer-readable signals among system components like user device(s) 108, smart display 102, and other device(s) 106 within a real estate context. For instance, it allows the transmission of data from a rental agency's computer system to smart display 102 showing property listings and tenant/buyer information. This network incorporates a multi-layer authentication process, ensuring secure access for users such as real estate agents and property managers, and enables authenticated user interactions with the system.

The display controller module 116, situated within the secure casting network 114, manages the creation and interaction of data windows across display devices in real estate settings. It processes signals from authenticated users, directing the arrangement and content of primary and secondary data windows. For example, in a rental agency, this module would control the display of rental property images in one window, while simultaneously showing tenant application details in another, ensuring a seamless multi-window experience for agents and clients.

The user interface module 118, integrated into the secure casting network 114, offers interactive capabilities for authenticated real estate professionals. It enables dynamic engagement with data windows, such as dragging and resizing windows displaying property floor plans or adjusting the layout to include demographic data alongside property listings. This module facilitates real-time interaction with the multi-window display system, enhancing the user experience for agents and property managers working with complex rental data.

The security module 120, part of the secure casting network 114, ensures the secure handling of multi-window content in real estate applications. It authenticates users through a multi-layer process, encompassing pattern recognition and permission-level checks. For example, when a property manager accesses tenant or buyer financial data, this module verifies their credentials before allowing manipulation of data windows, maintaining data security throughout the system.

The virtual tour module 122 enables the retrieval and display of comprehensive property data for virtual tours. This includes 3D images, pricing, location details, and neighborhood highlights. In a real estate agency, agents can use this module to present detailed virtual tours of properties on smart display 102, showcasing different property aspects in separate windows for potential tenants, buyers or investors. The module is designed to present a responsive, interactive virtual tour of a property. For example, a real estate agent can use this module to display a multi-faceted virtual tour in their office, showing floor plans, interior photos, neighborhood amenities, and lease terms in separate display windows. For on-site visits, the module can provide real-time property information, enhancing the visitor's experience. It ensures sensitive details like current tenants' or buyers' personal information or proprietary property data are securely managed and accessible only to authorized personnel, maintaining privacy and data security.

Rental management module 124 offers comprehensive display configurations for rental managers, accommodating various user roles such as landlords, owners, or superintendents. It provides a multi-window interface for displaying diverse property and tenant management or sales information. For example, in one window, property specifics can be shown, while another displays tenant profiles, rental applications, or financial trends. The module can also integrate maintenance schedules, vendor contacts, and local news or social media content relevant to the property. It facilitates efficient management communications, allowing property managers to securely present and discuss maintenance plans, tenant requests, and property status updates during meetings or virtual calls with property owners. This module ensures effective and secure management of multiple properties by centralizing essential information in an easily accessible format.

Application module 126 allows rental agencies to efficiently and securely process rental applications. It provides a multi-window system where one window can display the rental application form, another can show required personal documents, and a third window can be used for real-time credit checks or reference validations. This setup streamlines the application process, ensuring accuracy and data security, particularly when handling sensitive financial information. It enhances the user experience for both agents and clients, providing a transparent and interactive application process.

Property database 128 includes comprehensive data on rental properties. This database can store detailed property information, including square footage, age of the property, historical and current rental rates, occupancy rates, and utility details. It may also contain records of property improvements, inspection reports, and images or virtual tour data. This database becomes a critical tool for market analysis, property valuation, and investment decision-making.

Tenant and buyer database 130 stores extensive tenant-related information. It includes tenants' rental applications, financial information such as credit scores and employment history, occupancy details, contact information, and rental history. The database may also track tenant feedback and maintenance requests, aiding in responsive property management and tenant relationship building.

Management database 132 stores administrative and operational data for property management. It includes login credentials, property financial records, maintenance logs, compliance with local governance, and market information. This database aids in efficient property management by providing easy access to financial reports, tracking maintenance and repair activities, and ensuring compliance with local housing regulations and market trends.

Third party network 134 encompass a range of external services and platforms relevant to real estate and rental management. These networks include, but are not limited to, MLS (multiple listing service) for real-time property listings, background check agencies for tenant and buyer screening, credit reporting agencies for financial assessments, tenancy rights advocacy groups for legal compliance, social media services for marketing and community engagement, and mapping services for geographical and locational data. For example, a rental agency might access MLS through third party network 134 to obtain updated listings, or use a credit agency's services to evaluate a potential tenant's creditworthiness or buyer's preauthorization. Third party database 136 stores data and information sourced from third party network 134. This database integrates various types of third-party data, such as property listings from MLS, tenant credit reports from credit agencies, legal updates from tenancy rights groups, social media content for marketing analysis, and mapping data for property location insights. This information is crucial for comprehensive property management and tenant or buyerevaluation processes. For instance, property managers can access tenant background check results stored in third party database 136 to make informed leasing decisions. The cloud 138 or communication network facilitates data exchange within the system, supporting both wired and wireless connectivity. The network can employ various communication technologies, including visible light communication (VLC), WIMAX, LTE, WLAN, IR communication, PSTN, and radio waves. It enables rapid provisioning of resources and services with minimal management, functioning similarly to a public utility. The network supports cloud computing principles, allowing for the shared use of configurable system resources and higher-level services, enhancing operational efficiency and scalability. For example, a property manager or real estate agent may use the cloud 138 to access real-time property data from MLS or update tenant or buyer information remotely, leveraging the network's ubiquitous access and resource sharing capabilities

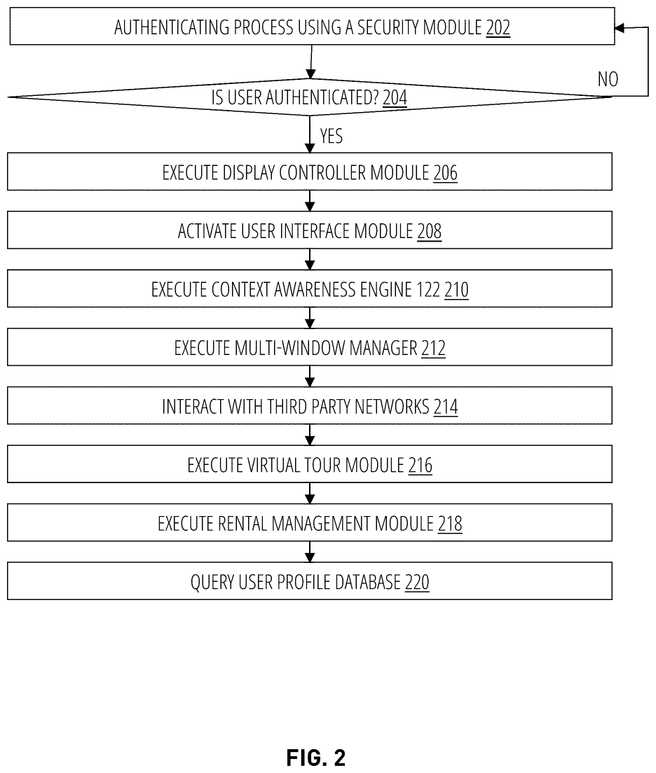

Functioning of the secure casting network 114 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The method may begin with the secure casting network 114 that initiates, establishing the primary framework for multi-window interactions within the real estate rental system. This involves activating communication pathways between system components such as user device(s) s 108, smart display 102, and other device(s) 106. In a real-world application, for instance, when a real estate agency activates the system, the secure casting network 114 enables the transmission of property listings from the agency's computer to smart display 102, where different properties are showcased in distinct windows. At step 202, a multi-layer authentication process involving the security module 120 is triggered. This process validates user access by verifying credentials against stored security protocols. For example, a property manager or real estate agent attempting to access tenant or buyer financial records would undergo authentication checks, such as biometric verification or password input, ensuring that only authorized personnel can access sensitive information.

At step 204, the system determines if the user, such as a real estate agent or rental property manager, is authenticated. This involves checking the user's credentials against the security standards set within the system. If authentication is successful, the user gains access to system features; for instance, a verified agent would be able to access property details and tenant/buyerinformation for client consultations. At step 206, the display controller module 116 is accessed. This module manages the distribution and display of content across multiple screens or windows. In practice, a real estate agent using this module could arrange a multi-window display showing a property's floor plan, images, and neighborhood information on different screens during a client presentation, enhancing the property showcasing experience.

At step 208, the user interface module 118 is activated, enabling user interactions across the system. This module facilitates functions such as resizing and rearranging display windows or switching between different data streams. For example, during a rental property tour, an agent could use this module to seamlessly switch between views of the property's interior, amenities, and local area maps. At step 210, a context awareness engine is engaged, making the system aware of the relevance of multiple windows. This engine adapts display content based on contextual cues. For example, if an agent is discussing a property's neighborhood amenities, the system could automatically highlight local schools and parks in adjacent windows, providing a comprehensive view to potential tenants and buyers.

At step 212, a multi-window manager operates to control the layout and interactions between multiple display windows. In a real-world scenario, this could involve a property management company using the system to display and manage maintenance schedules in one window while showing tenant requests and property status updates in others, ensuring efficient and secure communication during meetings or calls. At step 214, interaction with third party network 134 occurs to fetch or send data external to the secure casting network 114. For instance, a rental agency could use this step to access credit reports from a credit agency or legal updates from tenancy rights groups, integrating this external data into the system for comprehensive tenant screening and property management. At step 216, the virtual tour module is executed, providing smart display 102 with multiwindow virtual tour capabilities. A real estate agent, for example, could use this dynamic feature to conduct a detailed virtual tour of a property for prospective tenants and buyers, showcasing different aspects such as 3D views, floor plans, and area amenities in separate windows, enhancing the viewing experience and providing thorough property insights.

At step 218, the rental management module is executed, enabling smart display 102 to show property management information to an authorized user. This could involve a landlord using the system to simultaneously view and manage various aspects of property management, such as tracking rent payments, scheduling maintenance, and reviewing tenant communications, all presented in an organized multi-window format. At step 220, the user profile database 132 is queried to retrieve or update user-specific data. For example, a property manager updating tenant profiles after a lease renewal could use this step to access and modify tenant information, ensuring that records are current and accurately reflect tenant occupancy and lease details.

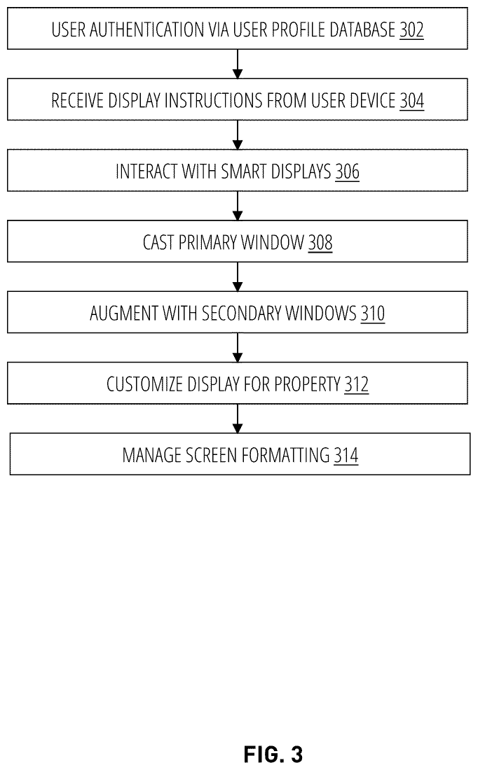

FIG. 3 displays an example method performed by the display controller module 116. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may begin with the display controller module 116 within the secure casting network 114 being initiates, functioning as a centralized orchestrator for managing multi-window displays. This module processes instructions received from user devices to control content layout across display screens. For example, in a real estate office, this module could orchestrate the simultaneous display of different properties on smart display 102, with each screen showing various aspects such as property images, details, and virtual tours.

At step 302, user authentication is conducted via the user profile database 132. This process ensures that the user has the necessary permissions to interact with specific system components such as smart display 102, sensor(s) 104, other device(s) 106-, or third-party networks 134. In practice, a property manager accessing the system would be authenticated to ensure they have the right to view and manage sensitive tenant or buyer data or property information.

At step 304, the display controller module 116 receives display instructions from user device(s) 108. This involves the module interpreting user commands and preferences for displaying specific content. For instance, a real estate agent might send instructions from a tablet to display a particular property's detailed information, which the module then processes for presentation on the appropriate display screens.

At step 306, the module interacts with smart display 102 within the smart home (?) environment. This step facilitates the display of user-selected content on the smart display 102. For example, in a rental agency, this could involve displaying high-resolution images of available properties or interactive floor plans for client perusal. At step 308, the primary media window is cast onto the designated display device. This involves the module selecting and projecting the main content onto a specific screen or window. For instance, during a property presentation, the primary window might showcase a virtual tour of the property, providing a dynamic and immersive viewing experience for clients.

At step 310, one or more contextually aware secondary windows are added to augment the primary media window. These secondary windows display supplementary information relevant to the primary content. For example, while a primary window displays a property tour, secondary windows could show local demographic data, nearby facilities, or real-time market analysis, providing comprehensive information to potential buyers or tenants. At step 312, the display is customized for a particular property, which includes highlighting amenities, nearby attractions, affordability, and demographic information. This optimization of primary and secondary windows is based on the property's highlights and specific selling points. For example, a property located in a family-friendly neighborhood might have its proximity to schools and parks highlighted in secondary windows.

At step 314, the display controller module 116 manages the formatting and resolution of content across multiple screens. This step ensures that the content displayed on different devices is consistent in terms of quality and layout, providing a seamless viewing experience. For instance, in a multi-screen setup in a real estate office, this module would ensure that property images and data are uniformly presented across all screens, regardless of their size or resolution.

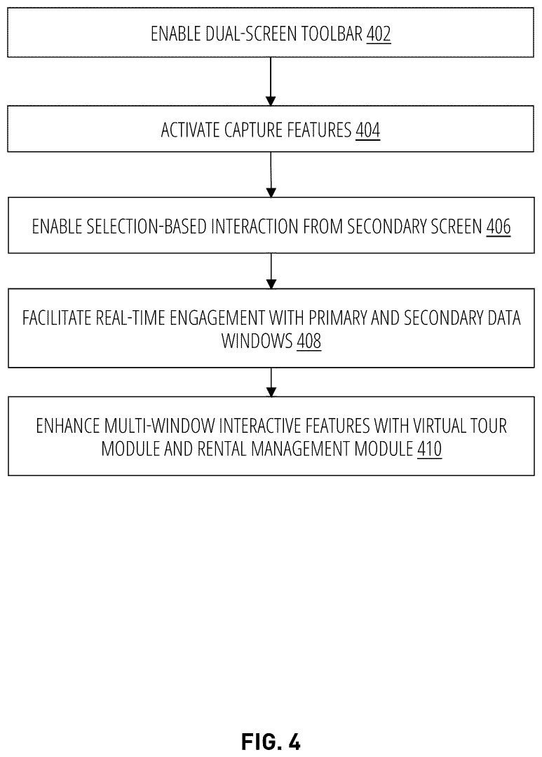

FIG. 4 displays an example method performed by the user interface module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may begin with the user interface module 118 within the secure casting network 114 begin initializes, enabling user interactions across multi-window displays. This module equips users with functionalities like selection, annotation, capture, and search within the system's interface. For instance, a real estate agent using this module could annotate and highlight specific features on virtual property tours displayed across multiple windows, enhancing the presentation and engagement with potential clients.

At step 402, the dual-screen toolbar within the user interface module 118 becomes operational, offering a suite of functionalities on a secondary screen. This toolbar allows users to perform actions such as capturing property information and activating additional information panels. In a practical scenario, a rental agent might use this toolbar to quickly capture QR codes of property listings, instantly bringing up detailed property information on the secondary screen for efficient client consultation. At step 404, capture features within the dual-screen toolbar are activated. These features enable users to capture data from the primary screen, like images of real estate properties. For example, during a property showcase, an agent can capture images of specific property features displayed on the primary screen and save them for later reference or to share with clients, or a prospective renter may save a capture from a virtual tour for later reference along with contextual property information.

At step 406, selection-based interaction is enabled on the secondary screen, allowing users to interact with content displayed on the primary screen. This step facilitates user engagement by enabling the selection of items on the primary screen through the secondary interface. For instance, a property manager could select different maintenance requests displayed on the primary screen by interacting with the secondary screen, streamlining the workflow. At step 408, real-time engagement with both primary and secondary data windows is facilitated by the user interface module 118. This step allows users to simultaneously engage with content displayed across multiple windows. In a real-world application, this dynamic feature could be used by real estate investors to interact with market analysis data on one window while viewing property portfolios on another, enabling a comprehensive and interactive investment assessment.

At step 410, multi-window interactive features are enhanced through integration with the virtual tour module 122 and rental management module 124. This enhancement provides users with a tailored experience for viewing property data, making user interaction dynamic and contextually relevant based on their roles, permissions, and specific use case. For example, a rental agency could use these integrated features to present a customized multi-window display showing virtual tours, tenant applications, and property management details, catering to the specific needs of different team members.

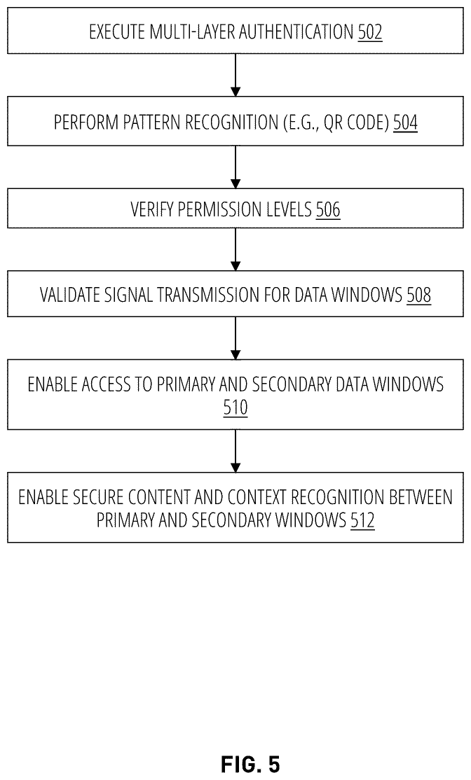

FIG. 5 displays an example method performed by the investor module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may begin with the security module 120 within the secure casting network 114 being initialized, setting the foundation for secure interactions across the system's multi-window displays. This module establishes the security protocols for both primary and secondary screens, ensuring that all data and interactions are securely managed. For instance, in a real estate office, this step would secure the smart display 102, ensuring that sensitive property and client data displayed are protected from unauthorized access. At step 502, a multi-layer authentication process, executed by the security module 120, involves verifying user credentials through various methods such as device id, biometrics, passwords, and two-factor authentication. This process ensures that only authorized users can access and interact with the system. For example, a property manager attempting to access tenant or buyer financial records would undergo this multi-layer authentication to ensure secure and appropriate access.

At step 504, pattern recognition mechanisms, like QR code scanning or a two-step authentication procedure, are conducted by the security module 120. This step assists in validating users and activating system functionalities. In a practical setting, a user device(s) 108 could scan a QR code displayed on a smart display 102 to securely cast property images or buyer/tenant information, streamlining the user's interaction with the system while maintaining security. At step 506, the security module 120 verifies permission levels for various functionalities within the system. This step confirms user authorization levels, granting or denying access based on their permissions. For instance, a rental agency employee with limited access might be able to view property listings but not tenant personal data, aligning with their authorization level within the system.

At step 508, the security module 120 validates the transmission of computer-readable signals to primary and secondary data windows. This validation is critical for ensuring the security and integrity of the content displayed. In a real-world application, this step might involve verifying a signal from a property manager's device before displaying sensitive tenant or buyer information on a smart display 102 in a secure and trusted manner. At step 510, access to primary and secondary data windows is enabled following user authentication and signal validation by the security module 120. Once these security checks are completed, the data windows become accessible for content display and interaction.

For example, after successful authentication, a real estate agent might gain access to multi-window displays showing various property details for client presentations. At step 512, secure content and context recognition between primary and secondary windows is enabled, utilizing a context awareness engine. This functionality allows the two screens to interact securely, recognizing and responding to the content and context displayed on each. For instance, in a property management scenario, the primary window might display maintenance requests, while the secondary window securely shows relevant tenant details or vendor contacts, enhancing operational efficiency.

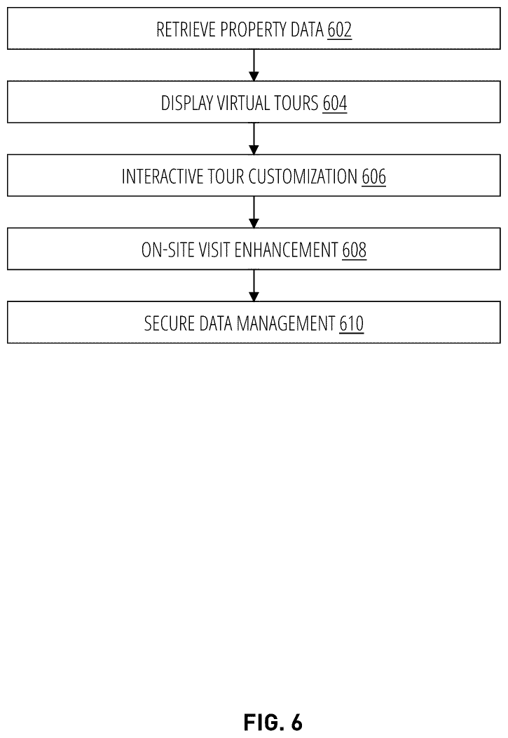

FIG. 6 displays an example method performed by the manage module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may begin with the virtual tour module 122 being initialized, setting up the system to retrieve and display detailed property data for virtual tours. This step involves activating the module within the secure multi-window real estate display system, enabling it to pull and process comprehensive property information. For instance, a real estate agent can initialize this module to prepare for a client meeting, where they plan to showcase several properties. They select properties from their portfolio, and the module readies the relevant data for display. Another example is a property manager who initializes the module to update virtual tours of their rental properties with the latest images and information, ensuring that the listings are current and appealing to potential tenants.

At step 602, the virtual tour module 122 retrieves property data, including 3D images, pricing, location details, and neighborhood highlights. This step involves accessing and compiling comprehensive data for each property to be showcased in the virtual tour. For example, a real estate agency may use this step to gather detailed information about a new listing, including high-resolution images of the property, current market pricing, and information about the local area's amenities. Another scenario could be a rental agency collecting updated information about an apartment complex, including recent renovations, amenities, and available units, to present to potential renters. At step 604, the system displays virtual tours on smart display 102. In this step, the virtual tour module 122 presents the gathered property data in an interactive and engaging format on the display screens. A real-life application could involve a real estate agent conducting a virtual open house, where they navigate through different parts of a property on a smart tv, showing potential buyers various features and rooms in detail. Alternatively, a property investor might use this dynamic feature to remotely tour multiple properties, comparing them in real-time to make informed investment decisions.

At step 606, the system enables interactive customization of the virtual tours. This step allows users to tailor the virtual tour experience based on client needs or specific property features. For example, a rental agent might customize a tour to focus on the unique features of a luxury apartment, such as its state-of-the-art kitchen or scenic balcony views, for high-end clients. In another instance, a property manager could customize the tour to highlight safety features and community amenities of a family-friendly apartment complex to appeal to potential tenants with families.

At step 608, the virtual tour module 122 enhances on-site property visits with real-time information. This step involves using the system to provide additional context and details during physical property tours. For example, during an on-site visit, a real estate agent might use a tablet to access real-time information about the property's history, recent upgrades, and neighborhood statistics, enriching the potential buyer's experience. Similarly, a property manager conducting a site visit with a contractor could use the system to access and discuss specific maintenance issues and renovation plans for the property.

At step 610, the system manages sensitive data securely within the virtual tour module 122. This step focuses on ensuring that personal and proprietary information related to the properties is accessible only to authorized individuals. For example, in a rental office, the system could restrict access to current tenants' personal details, only allowing authorized staff to view this information. In a brokerage firm, sensitive financial details about property investments might be securely managed within the system, ensuring that only designated agents and investors can access this data.

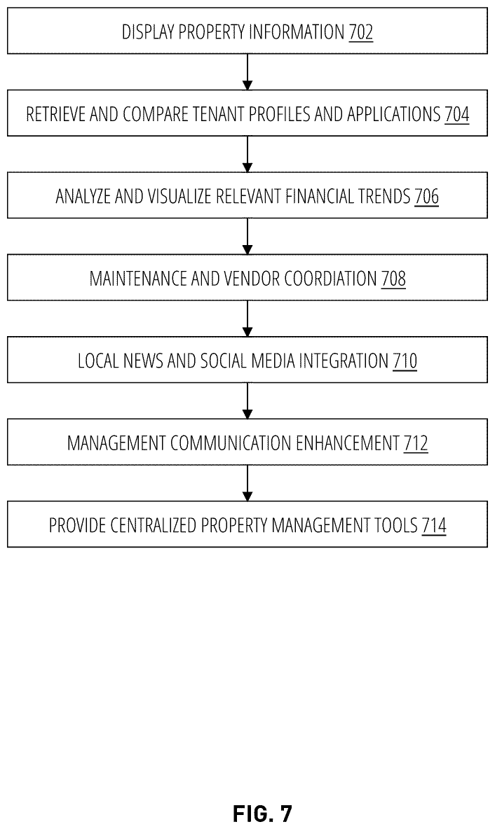

FIG. 7 displays an example method performed by the rental management module 124. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may begin with the rental management module 124 being initiated, enabling rental managers to access and manage a comprehensive, multi-window interface for property management. This module is equipped to display a range of property and tenant-related information efficiently. For instance, a landlord managing multiple properties initiates the module to view all their rental units, tenant information, and financial summaries in one integrated system.

Another example involves a property management company initiating the module at the start of their day to review and manage their portfolio of properties, tenant issues, and upcoming maintenance tasks, streamlining their workflow. At step 702, the module displays detailed property information in one of the multi-window interfaces. This includes specifics like property location, size, amenities, and current occupancy status. A real estate agent, for instance, can use this dynamic feature to show potential clients detailed information about various properties in their portfolio, including virtual tours, without needing to switch between different applications. Similarly, a rental property owner might use this step to keep track of their multiple properties, viewing real-time occupancy status, upcoming lease renewals, and maintenance needs all on one screen.

At step 704, the system retrieves and compares tenant or buyer profiles and applications. This involves pulling up current tenant information alongside prospective tenant applications for comparison and decision-making. For instance, a rental agency can use this step to quickly compare applications for a vacant apartment, assessing each candidate's suitability based on their profile and application details. Another example is a property manager using this dynamic feature to review tenant history and current applications to make informed decisions about tenant renewals and new leases. At step 706, the module analyzes and visualizes financial trends relevant to the properties. This includes rent trends, occupancy rates, and other financial metrics. A property investor might use this dynamic feature to analyze rental income trends across their portfolio, making decisions about rent adjustments or future investments. Similarly, a property management firm might utilize this step for financial reporting, tracking income and expenses across different properties to optimize financial performance.

At step 708, maintenance schedules and vendor coordination are integrated into the module. This step facilitates efficient management of property upkeep and vendor relationships. For instance, a building superintendent uses this step to schedule and track regular maintenance tasks, coordinate with vendors, and manage maintenance budgets. Another application could be a property management firm using this dynamic feature to centralize communication with multiple vendors, scheduling maintenance across various properties, and tracking completion and expenses. At step 710, the module integrates local news and social media content relevant to the properties. This dynamic feature helps managers stay updated with local events and trends that could impact their properties. For example, a landlord might use this dynamic feature to monitor neighborhood developments that could affect property values or rental demand. A property management company could use it to stay informed about local news, community events, or issues that might impact their tenants or property operations.

At step 712, the system enhances management communication. This step allows property managers to efficiently communicate with property owners, tenants, and staff. For instance, a property management team might use this dynamic feature during a virtual meeting with property owners to present property status updates, financial reports, and tenant or buyer issues. Another example is using the module for staff meetings, where the team reviews maintenance schedules, tenant, buyer or property owner communications, and operational updates. At step 714, centralized property management tools are provided by the module. This step streamlines various aspects of property management into one cohesive system.

For example, a rental property owner uses this dynamic feature to access all their property and tenant information, financial reports, and maintenance schedules in one place, saving time and improving decision-making. A large property management company might use this centralized system to manage multiple properties across different locations, ensuring consistency in management practices and easy access to important information. The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments

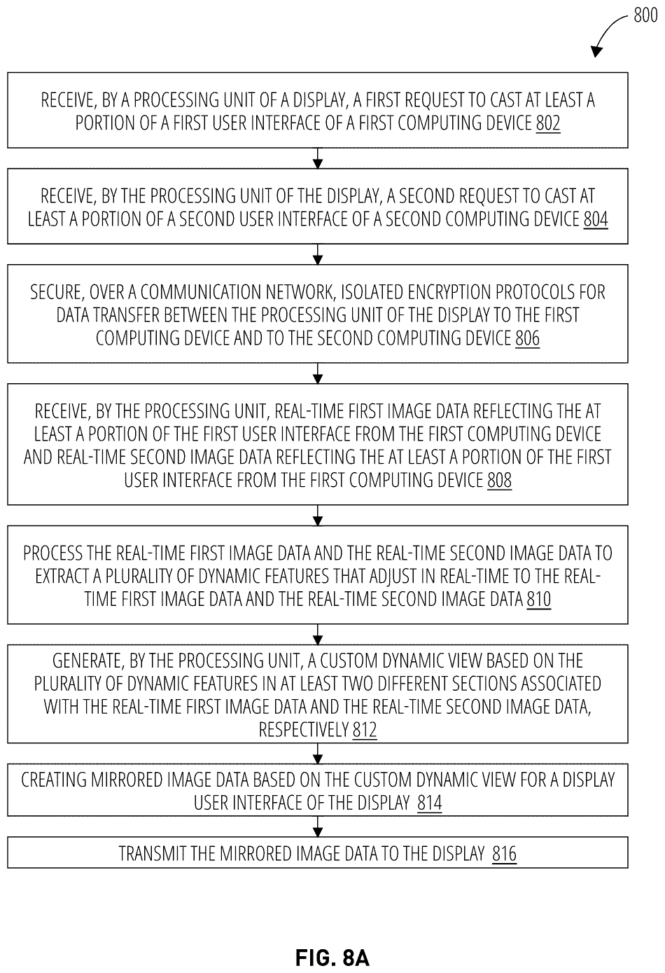

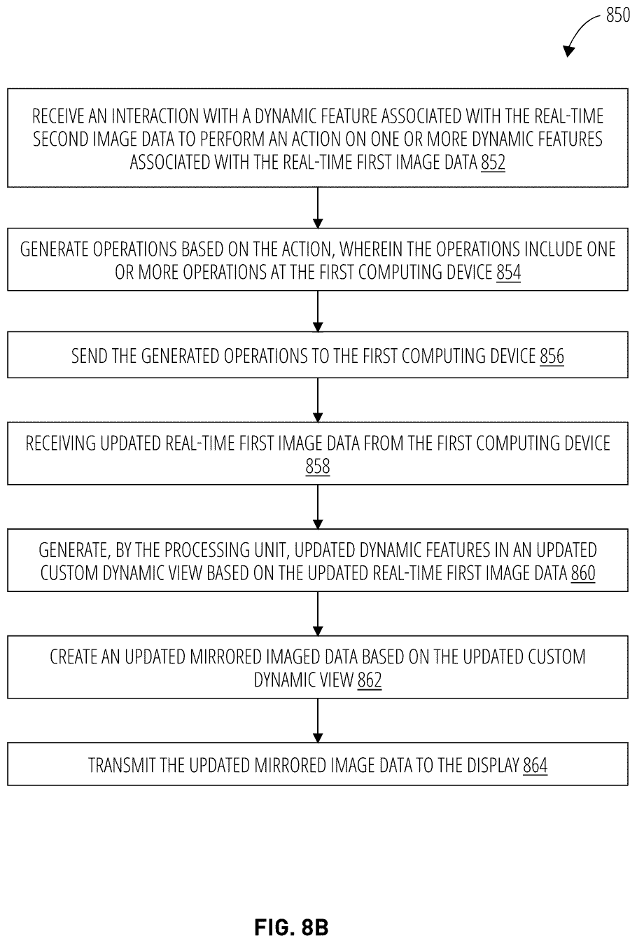

FIG. 8A illustrates an example method 800 for customizing a multi-view display with interactive and dynamic features. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method includes receiving, by a processing unit of a display, such as the smart display 102, a first request to cast at least a portion of a first user interface of a first computing device at step 802. In some cases, the first computing device is in secure communication with other device(s) 106, such as Internet of Things (IoT) devices including connected sensors and cameras. The first computing device may include the secure casting application 110 to interface with the secure casting network 114.

According to some examples, the method includes receiving, by the processing unit of the display, a second request to cast at least a portion of a second user interface of a second computing device at step 804. In some cases, the second computing device is in secure communication with the property database 128, the tenant and buyer database 130, the management database 132, or other third party database 136. The second computing device may include the secure casting application 110 to interface with the secure casting network 114. In some cases, a scannable symbol, such as QR code, may be generated to be displayed on the display. The first request and/or the second request may be based on a scan by the first computing device or the second computing device, respectively.

According to some examples, the method includes securing, over a communication network of the secure casting network 114, isolated encryption protocols for data transfer between the processing unit of the display to the first computing device and to the second computing device at step 806. The isolated encryption protocols may include, but are not limited to, Advanced Encryption Standard (AES), Secure Sockets Layer/Transport Layer Security (SSL/TLS), Internet Protocol Security (IPSec), and Hybrid Encryption protocols. Furthermore, the secure casting network 114 may employ additional security measures such as multi-factor authentication, intrusion detection systems, and regular software updates to ensure the confidentiality and integrity of the data transferred between the devices. In some cases, connection between the processing unit and the first computing device and/or between the processing unit and the second computing device may be further authenticated using a secure key exchange protocol.

According to some examples, the method includes receiving, by the processing unit, real-time first image data reflecting the at least a portion of the first user interface from the first computing device and real-time second image data reflecting the at least a portion of the first user interface from the first computing device at step 808. In some cases, the real-time first image data may be generated based on real-time sensor data from Internet of Things (IoT) devices in a real-world setting, such as on or near real estate properties.

In some cases, the updated real-time first image data includes a virtual tour view that is generated based on the real-time sensor data. The virtual tour view may be a generated virtual reality (VR) view or an augmented reality (AR) view that includes features based on the real-time sensor data. For example, the AR view might display virtual markers or labels overlaid on top of the real-world experience, such as on or near a respective real estate property, providing additional context or information about the surroundings being captured. Alternatively, the VR view could be a fully immersive experience that allows users to virtually step into the real estate property. While the VR view may be more immersive with in VR head-mounted displays (HMDs), the VR view may further be optimized for view in devices, such as mobile devices.

According to some examples, the method includes processing the real-time first image data and the real-time second image data to extract a plurality of dynamic features that adjust in real-time to the real-time first image data and the real-time second image data at step 810. In some cases, the display controller module 116 processes the real-time first image data and the real-time second image data. For example, the real-time first image data may include a first window displaying real-time footage of a security camera and a second window displaying environmental sensor data (e.g., temperature, humidity). The real-time second image data may include real estate property data (e.g., survey data, rental yields, property value over time).

In some cases, the dynamic features include the casted screens of the first computing device and the second computing device. In some cases, the dynamic features may be extracted from the casted screens and may include, for example, a first dynamic feature of an isolated window displaying the real-time footage of a security camera, A second dynamic feature is generated based on the displayed environmental sensor data, which serves as an overlay of respective sensor readings onto the real-time footage of the first dynamic feature. This overlay provides a spatially referenced visualization of the sensor data, allowing users to correlate the sensor readings with the corresponding locations within the property.

For instance, if the first dynamic feature displays a stitched video of sunlight exposure in a particular room, the second dynamic feature might display an overlay of temperature, humidity, or air quality sensor data onto the video. This overlay would highlight specific areas of the room where the sensors are located, enabling users to see how these environmental factors may impact the comfort and livability of the space. Similarly, if the first dynamic feature displays a map of a property's layout, the second dynamic feature might display an overlay of sensor data readings onto the map. This could include information such as temperature, motion detection, or smoke detector alerts, which would provide users with valuable insights into the property's condition and potential risks. The generated overlay may be designed to be highly customizable, allowing users to select from a range of sensor data types and visualization options to suit their specific needs. By integrating environmental sensor data into the display, the system provides an enhanced user experience that goes beyond simply showing real-time footage.

A combination of computer vision techniques, such as object detection and tracking algorithms, along with graphics programming may be used to capture and manipulate the video feed. Alternatively, software development kits (SDKs) specifically designed for screen capturing and window manipulation can be utilized to automate the process. Another possible implementation involves using a third-party library or API that provides a direct interface to the operating system's graphics drivers, allowing for seamless integration of the captured content into a new application window.

For example, the real estate property data embedded within the real-time second image data can be extracted as a third dynamic feature, which are then populated as interactive controls that, when engaged by the user, trigger an update to one of the dynamic features associated with the real-time first image data. This interaction-driven update mechanism enables users to dynamically modify their view of the property's characteristics, fostering a more immersive and engaging experience. For instance, selecting a specific region within the survey data may activate the display of new sensor or camera feeds for real-time footage corresponding to that selected area. The activation may be triggered by various user interactions, such as clicking on an interactive 3D model, zooming in on a specific location, or using gesture-based controls.

In some cases, a machine learning model, such as a neural network, may analyze the static survey data, such as maps and property layouts, to identify key areas and features that require camera feedback. The analysis may involve training the neural network, such as a convolutional neural network (CNN) on labeled datasets of survey images to learn patterns and relationships between the data. Once trained, the neural network can be used to detect specific regions or features within the survey data and generate corresponding coordinates for the camera locations. When a user interacts with a control associated with a particular region or feature in the survey data, the machine-learning model may analyze the real-time image data from the camera feed to identify which area has changed. A separate neural network may be trained on labeled datasets of camera images to learn object detection and tracking algorithms. The neural network can then be used to detect changes in the image data and generate coordinates for the corresponding region or feature in the survey data.

By linking the coordinates from the machine-learning model with the coordinates from the camera locations, display of real-time footage associated with the selected area may be triggered, providing a seamless interactive experience for users. Additionally, to automate this process, developers could use web development frameworks, which provide libraries and tools for working with cameras, APIs for machine-learning models, and templates for creating dynamic user interfaces. By leveraging these technologies, the system can be designed to automatically recognize survey data, generate coordinates for camera locations, detect changes in image data, and trigger the display of real-time footage in response to user interactions.

According to some examples, the method includes generating, by the processing unit, a custom dynamic view based on the plurality of dynamic features in at least two different windows associated with the real-time first image data and the real-time second image data, respectively at step 812.

The custom dynamic view may be generated by the display controller module 116. The different windows may be determined by a machine-learning model that receives inputs of the plurality of dynamic features and outputting respective windows and boundaries for dynamic features. The windows may be conceptualized as separate, self-contained regions within the overall display. According to some examples, the method includes creating mirrored image data based on the custom dynamic view for a display user interface of the display at step 814, and transmitting the mirrored image data to the display at step 816.

In some cases, the custom dynamic view may include an augmented reality (AR) view in one of the properties. Access to sensitive information contained within this virtual tour may be restricted, requiring authentication by a second computing device. A verification process may be implemented and involve the use of geolocation technology, which determines the physical location of the second computing device. If the location falls within a restricted zone, such as a secure facility or a private residence, the user may be required to authenticated to grant access to sensitive information.

For example, in the context of an AR virtual tour, a user may pose a question that requires access to sensitive information about the property. If the user is authenticated by the second computing device, which has been verified as being located outside of a restricted zone, they may receive access to the requested information. Authentication may use GPS or other location-determination methods to verify the physical location of the second computing device, fingerprint or facial recognition algorithms to confirm the identity of the user, or unique tokens that must be presented by the user's second computing device to access sensitive information. Securing the communication of the sensitive information may utilize encrypted data transfer, token-based authentication, or an authorization and authentication protocol.

FIG. 8B illustrates an example method 850 for customizing a multi-view display with interactive and dynamic features. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

After the mirrored image data is transmitted to the display at step 816, users may interact with the display. According to some examples, the method includes receiving an interaction with a dynamic feature associated with the real-time second image data to perform an action on one or more dynamic features associated with the real-time first image data at step 852. In some cases, the interaction with the dynamic feature associated with the real-time second image data that is tied to the action performed on the one or more dynamic features associated with the real-time first image data is generated based on the patterns and relationships determined by the neural network as mentioned in FIG. 8A.

According to some examples, the method includes generating operations based on the action at step 854. The operations may include one or more operations at the first computing device. For example, to perform actions on the one or more dynamic features, new features may need to be generated to perform the requested action. As an example, the one or more operations may include changing the source of the sensor or camera if the action is to view a different part of the real estate property based on an interaction that selection the different part on a survey map of the property based on real-time second image data. According to some examples, the method includes sending the generated operations to the first computing device at step 856.

According to some examples, the method includes receiving updated real-time first image data from the first computing device at step 858 and generating, by the processing unit, updated dynamic features in an updated custom dynamic view based on the updated real-time first image data at step 860. The interaction with the dynamic feature associated with the real-time first second user interface may be, for example, a request to filter historical footage based on one or more parameters associated with the action. The updated real-time first image data may include features associated with the filtered historical footage.

In some cases, the updated real-time first image data may be analyzing based on one of the actions at the second computing device. The analyzed real-time footage may be summarized and a new dynamic feature may be generated based on the summarization. The updated custom dynamic view may include the new dynamic feature. For example, the one of the actions may be based on a question of which room in a real estate property receives the most sunlight. Based on property data from the property database 128, one of the rooms may be determined and recordings of the sunlight in the room may be stitched and summarized into a video, through various methods, including video stitching and compression algorithms, to create a compact yet informative representation of the sunlight exposure in that room.

The stitched video can be further processed using machine learning models, such as convolutional neural networks (CNNs) or recurrent neural networks (RNNs), to extract key features and patterns, such as peak sunlight hours or average light intensity. Image processing and video manipulation frameworks and as well as numerical computations libraries may be used alongside the machine learning models that may be trained using deep learning frameworks that provide efficient implementations of CNNs and RNNs for image and video analysis tasks. The resulting summarized footage is then used to generate a new dynamic feature, which can be integrated into the custom dynamic view. This updated view may include interactive elements, such as hotspots or zoomable areas, that enable users to explore the summarized footage in more detail.

According to some examples, the method includes creating an updated mirrored imaged data based on the updated custom dynamic view at step 862 and transmitting the updated mirrored image data to the display at step 864. In some cases, users may be viewing the display while using the first computing device or the second computing device as a remote or Bluetooth device to further communicate with the display.

In some cases, one of the features may provide a virtual tour of a real estate property. An input from a user associated with the second computing device may be received either at the display or from the second computing device. The second computing device may be associated with an investor or a real estate agent, as an example. Second actions based on the received input may be generated and the actions may include one or more second actions at the first computing device. In some case, the input and the real-time first image data may be inputted at a machine-learning model applied by the processing unit. The machine-learning model may output the second actions.

For example, the received input may be a request or question associated with the data provided in the dynamic features associated with the real-time second image data. As an example, a user may ask how much would it cost to retrofit the second bedroom into a co-working space? The second actions may include switching the virtual tour to a perspective view of the second bedroom. In some cases, the perspective view may be generated based on views provided for the virtual tour. There may be further third actions requesting maintenance costs, quotes, and local demand data associated with property or similar properties that may be provided by the property database 128 that is accessed through the second computing device.

The one or more second actions may be sent to the first computing device, and a second updated real-time first image data that shows an updated virtual tour view based on the one or more second actions may be received. A second updated custom dynamic view may be generated, and a second updated mirrored imaged data may be created based on the second updated custom dynamic view, and transmitted to the display. The updated virtual tour view includes changes to an overlay that provides secondary information about the respective real estate property that responds to the inputted question regarding how much it would cost to retrofit the second bedroom into a co-working space. The estimate may be provided as the overlay and different estimates may trigger a different preview of the type of co-working space in the updated virtual tour view.

In some cases, an investor might want to compare two or more properties side-by-side along with financial metrics (estimated return on investments, estimated maintenance costs, etc.), and legal documents, and display all the windows all in a multi-view setup on the display. In some cases, the portion of the real-time first image data may be associated with the real-time footage at least two different real estate properties and the portion of the real-time second image data includes real estate agent data associated with the at least two different real estate properties.

In some cases, the custom dynamic view may be integrated with virtual visits that incorporate advanced technologies such as holographic images of agents or talking avatars on screen. This can create a more immersive and engaging experience for potential buyers, allowing them to interact with virtual representatives who can provide personalized guidance and information about properties. In some cases, the custom dynamic view may be provided in vehicles that seamlessly integrated viewing properties while on-the-go. Furthermore, the system can also provide guided map tours that are generated by the neural network based on the selection of multiple properties that the buyer wants to see or drive by. By analyzing user preferences and selecting multiple properties based on their interests, the neural network may generate a planned route that considers factors such as location, price range, and amenities. The properties may be independently selected or combined with the agent's guidance, ensuring that users receive a personalized experience that meets their specific needs.

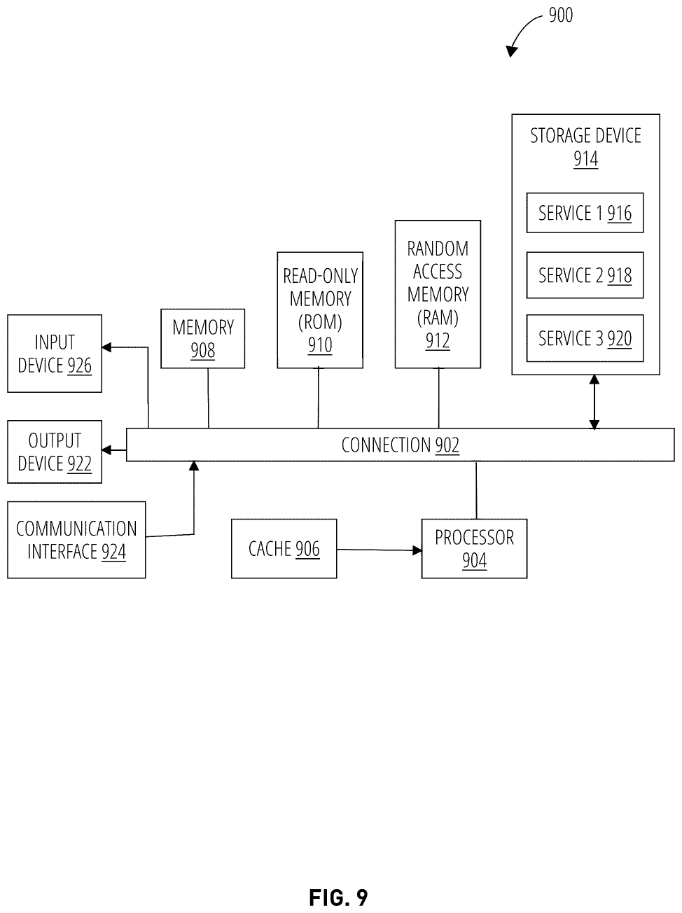

FIG. 9 illustrates a block diagram of an exemplary computing system that may be used to implement an embodiment of the present invention. The example of computer system 900 can be for example any computing device making up 100, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing computer system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing computer system 900 includes at least one processing unit (CPU or processor) 904 and connection 902 that couples various system components including system memory 908, such as read-only memory (ROM) 910 and random access memory (RAM) 912 to processor 904. Computing system 500 can include a cache of high-speed memory 908 connected directly with, in close proximity to, or integrated as part of processor 904.

Processor 904 can include any general purpose processor and a hardware service or software service, such as services 916, 918, and 920 stored in storage devices 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing computer system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computer system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the hardware components, such as processor 904, connection 902, output device 922, etc., to carry out the function.

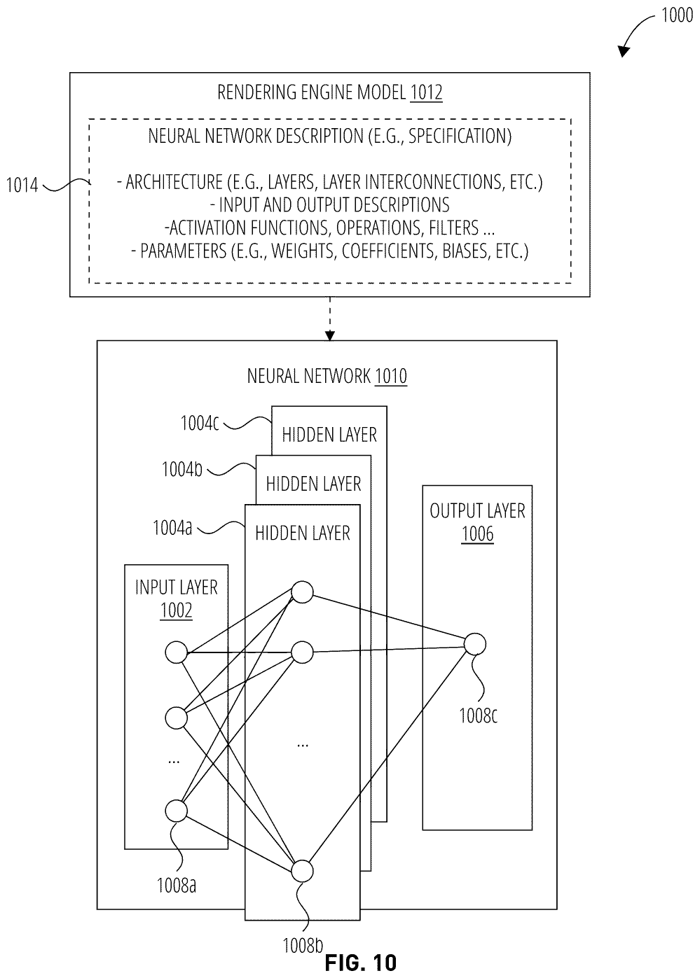

FIG. 10 illustrates an example neural network architecture.

Architecture 1000 includes a neural network 1004c defined by an example neural network description 1008a in node 1010c (neural controller). The neural network 6100 can represent a neural network implementation of a rendering engine for rendering media data. The neural network description 1008a can include a full specification of the neural network 1004c, including the neural network architecture 1000. For example, the neural network description 1008a can include a description or specification of the architecture 1000 of the neural network 1004c (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 1004c reflects the architecture 1000 defined in the input layer 1002. In this example, the neural network 1004c includes an input layer 1002, which includes input data, such sensor data, real estate data such financials or map data, or videos. The neural network 1004c includes hidden layers 504a through 1004 N (collectively “1004” hereinafter). The hidden layers 1004 can include n number of hidden layers, where n is an integer greater than or equal to one. The number of hidden layers can include as many layers as needed for a desired processing outcome and/or rendering intent.

The neural network 1004c further includes an output layer 1004b that provides an output (e.g., rendering output) resulting from the processing performed by the hidden layers 1004. In one illustrative example, the output layer 1004b can provide connections and interactions between dynamic features, windows for the dynamic features, a stitched video. The neural network 1004c in this example is a multi-layer neural network of interconnected nodes. Each node can represent a piece of information. Information associated with the nodes is shared among the different layers and each layer retains information as information is processed. In some cases, the neural network 1004c can include a feed-forward neural network, in which case there are no feedback connections where outputs of the neural network are fed back into itself. In other cases, the neural network 1004c can include a recurrent neural network, which can have loops that allow information to be carried across nodes while reading in input. Information can be exchanged between nodes through node-to-node interconnections between the various layers.

Nodes of the input layer 1002 can activate a set of nodes in the first hidden layer 504a. For example, as shown, each of the input nodes of the input layer 1002 is connected to each of the nodes of the first hidden layer 504a. The nodes of the hidden layers hidden layer 504a can transform the information of each input node by applying activation functions to the information. The information derived from the transformation can then be passed to and can activate the nodes of the next hidden layer (e.g., 504b), which can perform their own designated functions. Example functions include convolutional, up-sampling, data transformation, pooling, and/or any other suitable functions. The output of the hidden layer (e.g., 504b) can then activate nodes of the next hidden layer (e.g., 1004N), and so on. The output of the last hidden layer can activate one or more nodes of the output layer 1004b, at which point an output is provided. In some cases, while nodes (e.g., nodes 508a, 508b, 508c) in the neural network 1004c are shown as having multiple output lines, a node has a single output and all lines shown as being output from a node represent the same output value. In some cases, each node or interconnection between nodes can have a weight that is a set of parameters derived from training the neural network 1004c.

For example, an interconnection between nodes can represent a piece of information learned about the interconnected nodes. The interconnection can have a numeric weight that can be tuned (e.g., based on a training dataset), allowing the neural network 1004c to be adaptive to inputs and able to learn as more data is processed. The neural network 1004c can be pre-trained to process the features from the data in the input layer 1002 using the different hidden layers 1004 in order to provide the output through the output layer 1004b. In an example in which the neural network 1004c is used to identify connections and interactions between dynamic features, windows for the dynamic features, a stitched video, the neural network 1004c can be trained using training data that includes example connections and interactions between example dynamic features, example windows for the example dynamic features, or example stitched videos. For instance, training images can be input into the neural network 1004c, which can be processed by the neural network 1004c to generate outputs which can be used to tune one or more aspects of the neural network 1004c, such as weights, biases, etc. In some cases, the neural network 1004c can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 1004c, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 1004c is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 1004c can perform a backward pass by determining which inputs (weights) most contributed to the loss of the neural network 1004c, and can adjust the weights so that the loss decreases and is eventually minimized. A derivative of the loss with respect to the weights can be computed to determine the weights that contributed most to the loss of the neural network 1004c. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1004c can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 1004c can represent any other neural or deep learning network, such as an autoencoder, a deep belief nets (DBNs), a recurrent neural networks (RNNs), etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of customizing a multi-view display with interactive and dynamic features, comprising:
receiving, by a processing unit of a display, a first request to cast at least a portion of a first user interface of a first computing device;
receiving, by the processing unit of the display, a second request to cast at least a portion of a second user interface of a second computing device;
securing, over a communication network, isolated encryption protocols for data transfer between the processing unit of the display to the first computing device and to the second computing device;
receiving, by the processing unit, real-time first image data reflecting the at least a portion of the first user interface from the first computing device and real-time second image data reflecting the at least a portion of the first user interface from the first computing device;
processing the real-time first image data and the real-time second image data to extract a plurality of dynamic features that adjust in real-time to the real-time first image data and the real-time second image data;
generating, by the processing unit, a custom dynamic view based on the plurality of dynamic features in at least two different windows associated with the real-time first image data and the real-time second image data, respectively;
creating mirrored image data based on the custom dynamic view for a display user interface of the display;
transmitting the mirrored image data to the display;
receiving an interaction with a dynamic feature associated with the real-time second image data to perform an action on one or more dynamic features associated with the real-time first image data;
generating operations based on the action, wherein the operations include one or more operations at the first computing device;
sending the generated operations to the first computing device;
receiving updated real-time first image data from the first computing device;
generating, by the processing unit, updated dynamic features in an updated custom dynamic view based on the updated real-time first image data;
creating an updated mirrored imaged data based on the updated custom dynamic view; and
transmitting the updated mirrored image data to the display.

2. The computer-implemented method of claim 1, further comprising:
authenticating connection between the processing unit and the first computing device using a secure key exchange protocol; and
authenticating connection between the processing unit and the second computing device using another secure key exchange protocol, wherein the first computing device is isolated from the second computing device.

3. The computer-implemented method of claim 1, further comprising:
generating a scannable symbol to be displayed on the display, wherein the first request is based on a scan by the first computing device.

4. The computer-implemented method of claim 1, wherein the updated real-time first image data is generated based on real-time sensor data from Internet of Things (IoT) devices in a real-world setting.

5. The computer-implemented method of claim 4, wherein the updated real-time first image data includes a virtual tour view that is generated based on the real-time sensor data.

6. The computer-implemented method of claim 5, wherein the virtual tour view a generated virtual reality (VR) view or an augmented reality (AR) view that includes features based on the real-time sensor data.

7. The computer-implemented method of claim 4, wherein one of the operations at the first computing device is to filter historical footage based on one or more parameters associated with the action, wherein the updated real-time first image data includes features associated with the filtered historical footage.

8. The computer-implemented method of claim 7, further comprising:
analyzing the updated real-time first image data based on one of the actions at the second computing device;
summarizing the analyzed real-time footage; and
generating a new dynamic feature based on the summarization, wherein the updated custom dynamic view includes the new dynamic feature.

9. The computer-implemented method of claim 4, further comprising:
receiving an input from a user associated with the second computing device, either at the display or from the second computing device;
generating second actions based on the received input, wherein the actions include one or more second actions at the first computing device;
sending the one or more second actions to the first computing device;
receiving a second updated real-time first image data that shows an updated virtual tour view based on the input;
generating, by the processing unit, a second updated custom dynamic view;
creating a second updated mirrored imaged data based on the second updated custom dynamic view; and
transmitting the second updated mirrored image data to the display.

10. The computer-implemented method of claim 9, further comprising:
inputting, at a machine-learning model applied by the processing unit, the input and the real-time first image data; and
outputting, by the machine-learning model, the second actions.

11. The computer-implemented method of claim 9, wherein the updated virtual tour view includes changes to an overlay that provides secondary information about a respective real estate property.

12. The computer-implemented method of claim 1, wherein the updated custom dynamic view includes an augmented reality view, further comprising:
receiving a verification of a physical location of the second computing device;
determining the physical location is in a restricted zone; and
authenticating the second computing device for access to sensitive information.

13. The computer-implemented method of claim 1, wherein the second actions includes adding a new window in the second updated custom dynamic view, further comprising:
generating a new window based on the received updated real-time first image data and the updated real-time second image data.

14. The computer-implemented method of claim 13, further comprising:
inputting, at a machine-learning model applied by the processing unit, the updated real-time first image data;
outputting, by the machine-learning model, features for an additional view; and
triggering an action to add an additional view in the new window of the updated custom dynamic view, wherein the additional view in the updated custom dynamic view includes the features.

15. A display for customizing a multi-view display with interactive and dynamic features, comprising:
a storage configured to store instructions; and
one or more processors configured to execute the instructions and cause the one or more processors to:
receive a first request to cast at least a portion of a first user interface of a first computing device;
receive a second request to cast at least a portion of a second user interface of a second computing device;
secure, over a communication network, isolated encryption protocols for data transfer between the one or more processors of the display to the first computing device and to the second computing device;
receive real-time first image data reflecting the at least a portion of the first user interface from the first computing device and real-time second image data reflecting the at least a portion of the first user interface from the first computing device;
process the real-time first image data and the real-time second image data to extract a plurality of dynamic features that adjust in real-time to the real-time first image data and the real-time second image data;
generate a custom dynamic view based on the plurality of dynamic features in at least two different windows associated with the real-time first image data and the real-time second image data, respectively;
create mirrored image data based on the custom dynamic view for a display user interface of the display;
transmit the mirrored image data to the display;
receive an interaction with a dynamic feature associated with the real-time second image data to perform an action on one or more dynamic features associated with the real-time first image data;
generate operations based on the action, wherein the operations include one or more operations at the first computing device;
send the generated operations to the first computing device;
receive updated real-time first image data from the first computing device;
generate updated dynamic features in an updated custom dynamic view based on the updated real-time first image data;
create an updated mirrored imaged data based on the updated custom dynamic view; and
transmit the updated mirrored image data to the display.

16. The display of claim 15, wherein one of the operations at the first computing device is to filter historical footage based on one or more parameters associated with the action, wherein the updated real-time first image data includes features associated with the filtered historical footage, wherein the one or more processors are configured to execute the instructions and cause the one or more processors to:
analyzing the updated real-time first image data based on one of the actions at the second computing device;
summarizing the analyzed real-time footage; and
generating a new dynamic feature based on the summarization, wherein the updated custom dynamic view includes the new dynamic feature.

17. The display of claim 15, wherein the one or more processors are configured to execute the instructions and cause the one or more processors to:
receiving an input from a user associated with the second computing device, either at the display or from the second computing device;
generating second actions based on the received input, wherein the actions include one or more second actions at the first computing device;
sending the one or more second actions to the first computing device;
receiving a second updated real-time first image data that shows an updated virtual tour view based on the input;
generating a second updated custom dynamic view;
creating a second updated mirrored imaged data based on the second updated custom dynamic view; and
transmitting the second updated mirrored image data to the display.

18. The display of claim 17, wherein the one or more processors are configured to execute the instructions and cause the one or more processors to:
inputting, at a machine-learning model applied by a processing unit, the input and the real-time first image data; and
outputting, by the machine-learning model, the second actions.

19. The display of claim 17, wherein the updated virtual tour view includes changes to an overlay that provides secondary information about a real estate property.

20. A non-transitory computer readable medium comprising instructions, the instructions, when executed by a computing system, cause the computing system to:
receive a first request to cast at least a portion of a first user interface of a first computing device;
receive a second request to cast at least a portion of a second user interface of a second computing device;
secure, over a communication network, isolated encryption protocols for data transfer between a processing unit of a display to the first computing device and to the second computing device;
receive real-time first image data reflecting the at least a portion of the first user interface from the first computing device and real-time second image data reflecting the at least a portion of the first user interface from the first computing device;
process the real-time first image data and the real-time second image data to extract a plurality of dynamic features that adjust in real-time to the real-time first image data and the real-time second image data;
generate a custom dynamic view based on the plurality of dynamic features in at least two different windows associated with the real-time first image data and the real-time second image data, respectively;
create mirrored image data based on the custom dynamic view for a display user interface of the display;
transmit the mirrored image data to the display;
receive an interaction with a dynamic feature associated with the real-time second image data to perform an action on one or more dynamic features associated with the real-time first image data;
generate operations based on the action, wherein the operations include one or more operations at the first computing device;
send the generated operations to the first computing device;
receive updated real-time first image data from the first computing device;
generate updated dynamic features in an updated custom dynamic view based on the updated real-time first image data;
create an updated mirrored imaged data based on the updated custom dynamic view; and
transmit the updated mirrored image data to the display.
